(19) United States
(12) Patent Application Publication
(10) Pub. No.: US 2024/0318103 A1
(43) Pub. Date: Sep. 26, 2024

(54) SOAP OR DETERGENT BAR

(71) Applicant: PEP TECHNOLOGIES PVT. LTD., Mumbai, Maharashtra (IN)

(72) Inventor: Vikas LACHHWANI, Bengaluru (IN)

(21) Appl. No.: 18/245,106

(22) PCT Filed: Aug. 31, 2021
(86) PCT No.: PCT/IB2021/057930

§ 371 Date: Mar. 13, 2023

(30) Foreign Application Priority Data
Sep. 11, 2020 (IN) 2021039404

(51) Int. Cl. C11D 17/00

(52) U.S. Cl. CPC C11D 17/0047

(57) ABSTRACT

According the present invention there is provided a soap or detergent bar including: (a) a top surface (1), and; (c) a bottom surface (2), and; (d) a groove (3) running across its top surface from a first end (31) to a second 10 end (32), wherein the height (311) of the first end (31) as measured from the bottom surface (2) is greater than the height (321) of the second end (32) as measured from the bottom surface (2).

### TECHNICAL FIELD

The present invention relates to soap or detergent bars. In particular it relates to soap bars.

### BACKGROUND AND PRIOR ART

Soap or detergent bars face a major problem of wastage during storage between the use occasions. Typically the bars are wet after use, water accumulated around the bar dissolves and erodes away part of the bar that remains in contact with water for longer duration, thus leading to wastage. In storage, bottom surface of the bar that is in contact with water erodes away.

Furthermore, water often accumulates on the top surface of the bar forming a mushy layer, which erodes away in the use, again leading to wastage.

Soap dishes of various types are used in practice, to reduce water contact with bar by allowing water to drain away.

WO2003046119A1 (Unilever) discloses a solid shaped detergent compositions comprising 0.5-95% by weight detergent active and 0-90% by weight of inorganic particulates and/or other conventional ingredients and wherein the external surface of said shaped detergent composition comprises at least one polymer film obtained by radiation curing or a radiation-curable resin composition. Such bars are not convenient to apply on human body as the polymer film prevents application of soap to the skin.

Therefore, there remains a need for soap or detergent bars which allow draining away of water thus reducing wastage yet being convenient to apply.

### OBJECTS OF THE INVENTION

It is therefore an object of the present invention to reduce wastage of soap or detergent bars during storage between the use occasions.

Another object of the invention is to reduce area of contact of water with the soap bar during storage.

Present inventors have surprisingly found that by adding specific shape related features to the bars allows to reduce wastage of soap bars.

### SUMMARY OF THE INVENTION

According the the present invention there is provided a soap or detergent bar including:
(a) a top surface (1), and;
(b) a bottom surface (2), and;
(c) a groove (3) running across its top surface from a first end (31) to a second end (32), wherein the height (311) of the first end (31) as measured from the bottom surface (2) is greater than the height (321) of the second end (32) as measured from the bottom surface (2).

### DETAILED DESCRIPTION OF THE INVENTION

According the present invention there is provided a soap or detergent bar including:
(a) a top surface (1), and;
(b) a bottom surface (2), and;
(c) a groove (3) running across its top surface from a first end (31) to a second end (32), wherein the height (311) of the first end (31) as measured from the bottom surface (2) is greater than the height (321) of the second end (32) as measured from the bottom surface (2).

It was found that the feature of groove (3) according to the invention, as positioned on the top surface (1) creates a downward slope from the first end (31) to the second end (32), provides functional benefit of carrying down water from top surface (2) by gravity away from the top surface (1) thus preventing or at least reducing the water accumulation on the top surface (1) during storage. Thereby, the soap bar of the present invention has less wastage during storage, or in case water gets splashed on top surface, as the soap bar is normally stored in bath room or shower room. The top surface (1) may be planar, convex or concave.

The groove (3) from the first end to (31) to the second end (32) may be linear or may be curved. If curved it may be concave or convex, preferably convex. It will be appreciated that the curved groove (3) with a convex shape will help in creating a gravitational gradient that will allow drainage of water from the top surface (1) from both the ends (31) and (32), thus helping to reduce wastage.

According to a preferred aspect of the invention, the bottom surface (2) includes a basal plane (4) that functions as a support for the soap bar, wherein said basal plane (4) is defined by any one of the following:
(a) bottom surface (2) includes at least three basal segments (41, 42, 43) jutting outwards from the bottom, with the extremities of the segments being coplanar, thus defining a basal plane (4), or;
(b) the bottom surface (2) is planar, thus defining a basal plane (4), or;
(c) the bottom surface (2) is concave, and includes a bottom peripheral rim (44) that is planar, thus defining the basal plane (4).

It will be appreciated that the feature of the basal plane (4) according to the present invention, positioned at the bottom of the soap bar, functions as a support for the soap bar, thus maintaining its orientation during use in such a way that the feature of the groove (3) on the top surface (1) is enabled for draining away any water accumulation on the top surface (1) during storage, or in case water is splashed on the top surface (1) during storage in bath room or shower room

According to a further preferred aspect, the soap or detergent bar has an area ratio that is less than or equal to 0.95, and greater than or equal to 0.05, where the area ratio is defined as ratio of area of the bottom surface (2) as projected on basal plane (4) to the area of the top surface (1) as projected on basal plane (4). The area ratio is preferably less than 0.9, more preferably less than 0.8, further preferably less than 0.7, and most preferably less than 0.6. The area ratio is preferably greater than 0.1, more preferably greater than 0.2, further preferably greater than 0.3 and most preferably greater than 0.4.

The area ratio less than 0.95 functions to reduce the contact area of the bottom surface (2) with any water that may be present thus reducing wastage. It will be appreciated that further reduction in the area ratio below 0.95 further reduces the contact area with the bottom surface (2) and thereby further reduces wastage. At the same time, it will be appreciated that the area ratio greater than 0.05 helps the bar to be stably placed in upright position during storage without toppling, which helps in the feature of the groove (3) to carry water down and away from the top surface (1) thus reducing wastage. The increase in the area ratio beyond 0.05 improves the ability of the bar to be stably placed in upright position thus reducing wastage. Depending on the overall dimensions and shape of the bar, a practitioner in the art may easily be able to choose the area ratio that helps in reduction in wastage as well as helps in maintaining the stability of the bar during storage without toppling. It is thus preferred that the area ratio is from 0.3 to 0.7.

It is further preferred that the difference between the height (311) of the first end (31) and the height (321) of the second end (32) is greater than or equal to 1 mm. The difference between the height (311) of the first end (31) and the height (322) of the second end (32) is preferably greater than 3 mm, more preferably greater than 5 mm, further preferably greater than 7 mm and most preferably greater than 10 mm.

It will be appreciated that greater difference between the heights provides steeper gradient between the first end (31) to the second end (32) allowing for faster drainage of water away from the top surface (1) thus helping to further reduce the wastage.

According to yet another aspect of the invention, it is preferred that angle (6) between a top plane (5) and a basal plane (4) is at least 5 degrees, where the top plane is defined by any of the following:
(a) the top surface (1), excluding the groove (3), is planar, thus defining a top plane (5), or;
(b) the top surface (1) has a top rim (51), said top rim is planar, thus defining the top plane (5).

The angle (6) is preferably greater than 10 degrees, more preferably greater than 15 degrees, further preferably greater than 20 degrees and most preferably greater than 30 degrees. The angle (6) is preferably less than 85 degrees, more preferably less than 70 degrees, further preferably less than 55 degrees and most preferably less than 45 degrees.

The present inventors found that the feature of the invention where the angle (6) between the top plane (5) and the basal plane (4) helps in creating a gravitational gradient to drain away water from the top surface, with higher the angle (6) above 5 degrees, steeper the gradient and faster the rate of removing water away from and down the top surface (1). At the same time, the angle (6) needs to be below 85 degrees in order to maintain the bar in a shape that can be handled by the user.

It is further preferred that groove (3) includes a blocked portion (33) selected from one or both of the following:
(a) a blocked portion (331) positioned at the first end (31) of the groove (3), or;
(b) a blocked portion (332) positioned at the second end (32) of the groove (3)

According to a further preferred aspect, the groove includes a blocked portion (33) including both of the following:
(a) a blocked portion (331) positioned at the first end (31) of the groove (3), and;
(b) a blocked portion (332) positioned at the second end (32) of the groove (3).

It is normal practice to have logos or other markings or insignia on the top surface (1) of the bar. These are generally introduced by stamping. In case any logos or markings or insignia are present on the top surface (1), the top plane (5) is defined by the part of the top surface that is planar, excluding the groove (3) and excluding any logo or insignia or markings on the top surface (1).

Composition of soap bars or detergent bars and process of manufacturing thereof: Soap or detergent bar according to the present invention may be prepared using compositions of such bars known in the art, and need not be limited to a specific composition. The composition of soap bar or detergent bar according the present invention may comprise preferably 5-90% by weight total fatty matter or non-soap detergent. Soap bar composition preferably comprises 20-90% of total fatty matter. Detergent bar composition preferably comprises 5-50% of non-soap detergents. The soap or detergent bar further preferably comprises 3-40% water. The compositions of soap or detergent bar may include further ingredients known in the art, including but not limited to solid fillers such as clay, perfumes, chelating agents, preservatives, colour, etc.

The soap bars or detergent bars may be manufactured by processes known in the art. Such process include, but are not limited to melt casting and extrusion. The soap bars may be given a shape according to the invention by using moulds. Soap or detergent bars may be prepared by the process of extrusion, followed by introducing into a die a block of relatively soft extrudate material from which the soap or detergent bar is to be formed. Typically, dies are provided with cavities through which cooling water passes to cool the dies.

### BRIEF DESCRIPTION OF THE DRAWINGS

FIG. 1: First embodiment of the soap bar. FIG. 1a-front view, FIG. 1b: side view, FIG. 1c: top view

FIG. 2: Second embodiment of the soap bar: FIG. 2a: front view, FIG. 2B, side view, FIG. 2 C, top view

FIG. 3: Third embodiment of the soap bar: FIG. 3a: front view, FIG. 3b side view

FIG. 4: Fourth embodiment of the soap bar. FIG. 4a: front view, FIG. 4b: side view, FIG. 4c: bottom view

FIG. 5: Fifth embodiment of the soap bar. FIG. 5a: front view, FIG. 5b: side view, FIG. 5c: bottom view

FIG. 6: Sixth embodiment of the soap bar. FIG. 6a: front view, FIG. 6b: side view, FIG. 6c: top view

FIG. 7: Seventh embodiment of the soap bar. FIG. 7a: front view

FIG. 8: Eighth embodiment of the soap bar. FIG. 8a: front view, FIG. 8b: side view, FIG. 8c: top view

FIG. 9: Ninth embodiment of the soap bar. FIG. 9a: front view, FIG. 9b: side view, FIG. 9c: top view

FIG. 10. Tenth embodiment of the soap bar. FIG. 10a: front view, FIG. 10b: side view, FIG. 10c: top view

### DETAILED DESCRIPTION OF THE EMBODIMENTS

Hereinafter, a mechanical pencil drawing in accordance with the present invention will be described with reference to the embodiments illustrated in the drawings.

### FIG. 1

FIG. 1 depicts a first embodiment of the soap bar according to the present invention. The soap bar includes a top surface (1), a bottom surface (2), and a groove (3) running across its top surface from one end (31) to the other end (32). The height (311) of the first end (31) as measured from the bottom surface (2) is greater than the height (321) of the second end (32) as measured from the bottom surface (2), and the difference in the heights (311) and 321) is 5 mm. The cross section of the groove (3) at the end (32) is the shape of the letter V, with the depth of the groove increasing from zero at the end (31) to 5 mm at the end (32) in a linear manner. It will be appreciated that the feature of the groove (3) that slopes down from one end (31) to the other end (32), such that the height (311) is greater by 5 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar.

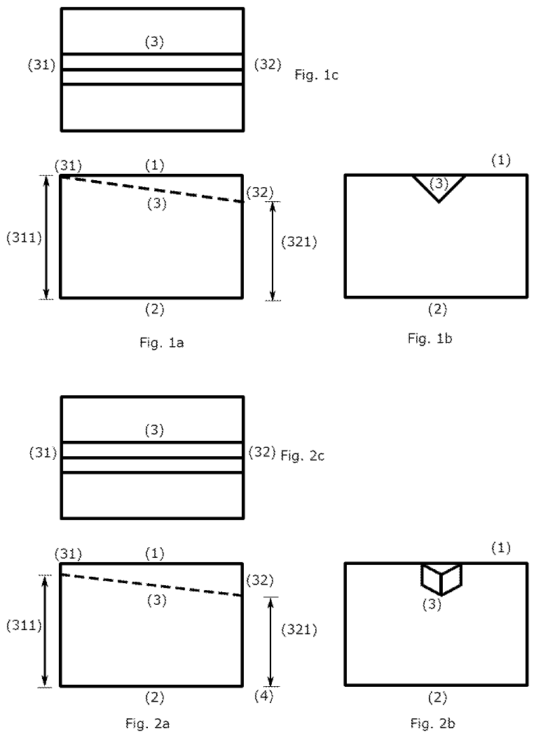

### FIG. 2

FIG. 2 depicts a second embodiment of the soap bar according to the present invention. The soap bar includes a top surface (1), a bottom surface (2), and a groove (3) running across its top surface from one end (31) to the other end (32). The height (311) of the first end (31) as measured from the bottom surface (2) is greater than the height (321) of the second end (32) as measured from the bottom surface (2), and the difference in the heights (311) and 321) is 5 mm. The cross section of the groove (3) at both the ends (31) and (32) is identical and of the shape of the letter V. The feature of the groove (3) that slopes down from one end (31) to the other end (32), such that the height (311) is greater by 5 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar.

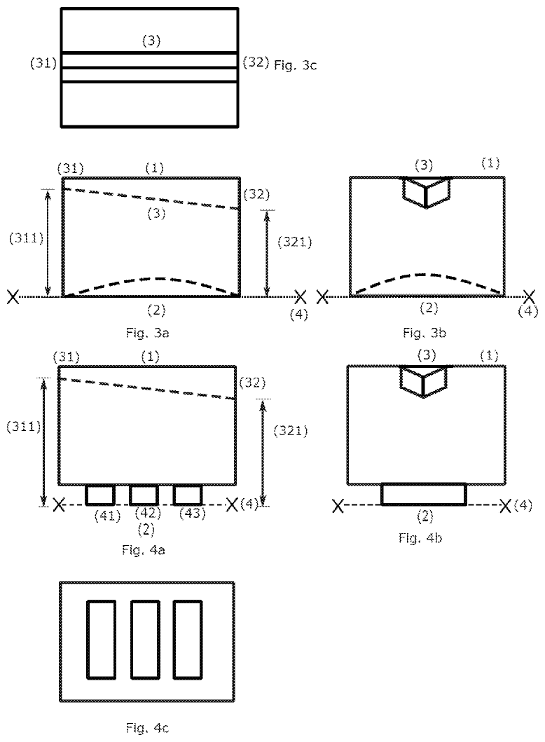

### FIG. 3

FIG. 3 depicts a third embodiment of the soap bar according to the present invention. The soap bar includes a top surface (1), a bottom surface (2), and a groove (3) running across its top surface from one end (31) to the other end (32). The height (311) of the first end (31) as measured from the bottom surface (2) is greater than the height (321) of the second end (32) as measured from the bottom surface (2), and the difference in the heights (311) and 321) is 5 mm. The cross section of the groove (3) at both the ends (31) and (32) is identical and of the shape of the letter V. The bottom surface (2) is concave, and includes a bottom peripheral rim (44) that is planar, thus defining the basal plane (4). The basal plane (4) forms the support for the soap bar. The feature of the groove (3) that slopes down from one end (31) to the other end (32), such that the height (311) is greater by 5 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar. Further, the feature of the concave bottom surface (2) including the planar peripheral rim (44) and defining a basal plane (4) allows for significant reduction in area of the soap bar that would be in contact with water during storage. The contact of the bottom surface with the water gets limited to just the peripheral rim (44). Thus the concave bottom surface (2) combined with peripheral rim (44) defining the basal plane allows the bar to be supported with minimum contact with water and thus facilitates reduction of wastage of soap bar.

### FIG. 4

FIG. 4 depicts a fourth embodiment of the soap bar according to the present invention. The soap bar includes a top surface (1), a bottom surface (2), and a groove (3) running across its top surface from one end (31) to the other end (32). The height (311) of the first end (31) as measured from the bottom surface (2) is greater than the height (321) of the second end (32) as measured from the bottom surface (2), and the difference in the heights (311) and 321) is 5 mm. The cross section of the groove (3) at both the ends (31) and (32) is identical and of the shape of the letter V. The feature of the groove (3) that slopes down from one end (31) to the other end (32), such that the height (311) is greater by 5 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar. The bottom surface (2) includes three basal segments (41, 42, 43) jutting outwards from the bottom with the extremities of the segments being coplanar, thus defining a basal plane (4). The basal plane (4) functions as support for the soap bar. It will be appreciated that the feature of the basal segments (41, 42, 42) forming a basal plane (4) functions as support for the bar when stirred between uses, allow significantly reduced contact area with water and thus reduces wastage.

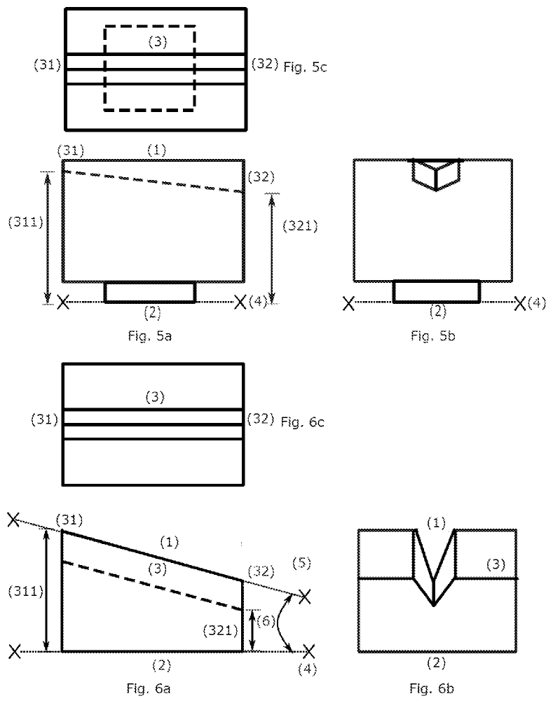

### FIG. 5

FIG. 5 depicts a fifth embodiment of the soap bar according to the present invention. The soap bar includes a top surface (1), a bottom surface (2), and a groove (3) running across its top surface from one end (31) to the other end (32). The height (311) of the first end (31) as measured from the bottom surface (2) is greater than the height (321) of the second end (32) as measured from the bottom surface (2), and the difference in the heights (311) and 321) is 5 mm. The cross section of the groove (3) at both the ends (31) and (32) is identical and of the shape of the letter V. The bottom surface (2) is shaped in such a way that the area ratio, defined as ratio of area of the bottom surface (2) as projected on basal plane (4) to the area of the top surface (3) as projected on basal plane (4) is about 0.3.

The feature of the groove (3) that slopes down from one end (31) to the other end (32), such that the height (311) is greater by 5 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar. It will be further appreciated that the feature of the area ratio being less than 0.95 allows for reduction in the area of soap surface in contact with water when supported on the bottom surface (2), and thus allows reduction in wastage of soap.

### FIG. 6

FIG. 6 depicts a sixth embodiment of the soap bar according to the present invention. The soap bar includes a top surface (1), a bottom surface (2), and a groove (3) running across its top surface from one end (31) to the other end (32). The height (311) of the first end (31) as measured from the bottom surface (2) is greater than the height (321) of the second end (32) as measured from the bottom surface (2), and the difference in the heights (311) and 321) is 15 mm. The cross section of the groove (3) at both the ends (31) and (32) is identical and of the shape of the letter V. The top surface (1), excluding the groove (3), is planar, thus defining a top plane (5). The bottom surface (2) is planar and forms a basal plane (4) that functions as the support for the soap bar. The top plane (5) and the basal plane (4) are at an angle (6) such that the entire top surface (1) of the bar slopes downwards from the end (31) to the end 32). In the depicted embodiment, the angle is 15 degrees. It will be appreciated that the feature of the groove (3) that slopes down from one end (31) to the other end (32), such that the height (311) is greater by 15 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar. Furthermore, it will be appreciated that due to the feature of angle (6) between the top plane (5) and the basal plane (4), the entire top surface is sloping downward from the end (31) to the end (32) thus allowing any water that on the top surface to slide down the top surface by gravity, preventing any accumulation of water on the top surface (2) and thus reducing wastage.

### FIG. 7

FIG. 7 depicts a seventh embodiment of the soap bar according the present invention. It is similar to the sixth embodiment depicted in FIG. 6, but with an additional feature where the bottom surface (2) is shaped in such a way that the area ratio, defined as ratio of area of the bottom surface (2) as projected on basal plane (4) to the area of the top surface (3) as projected on basal plane (4) is about 0.3. It will be appreciated that this embodiment would allow further reduction in wastage of bar due to the feature of the area ratio being less than 0.95, which allows for reduction in the area of soap surface in contact with water when supported on the bottom surface (2), and thus allows reduction in wastage of soap.

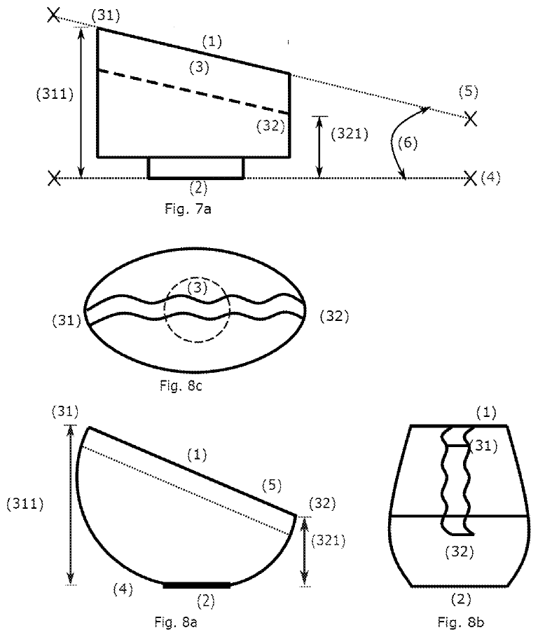

### FIG. 8

FIG. 8 depicts an eighth embodiment of the soap bar according to the present invention. The soap bar includes a top surface (1), a bottom surface (2), and a groove (3) running across its top surface from one end (31) to the other end (32), the groove is curved in a zig zag manner. The height (311) of the first end (31) as measured from the bottom surface (2) is greater than the height (321) of the second end (32) as measured from the bottom surface (2), and the difference in the heights (311) and 321) is 15 mm. The cross section of the groove (3) at both the ends (31) and (32) is identical and of the shape of the letter U. The top surface (1), excluding the groove (3), is planar, thus defining a top plane (5). The bottom surface (2) is planar and forms a basal plane (4) that functions as the support for the soap bar. The top plane (5) and the basal plane (4) are at an angle (6) such that the entire top surface (1) of the bar slopes downwards from the end (31) to the end 32). In the depicted embodiment, the angle is 15 degrees. It will be appreciated that the feature of the groove (3) that slopes down from one end (31) to the other end (32), such that the height (311) is greater by 15 mm than the height (321), allows the groove (3) to drain out excess water away from the top surface (1) and run down from the end (322) by gravity. Therefore, when the bar is wet after use such as bathing or when exposed to water during typical storage in bathroom or shower room, can reduce the amount of water that is in contact with top surface (1) by facilitating drainage of water from the top surface (1) via the groove (3) by gravity, thus allowing quicker drying and reducing formation of mush and/or wastage of soap bar. Furthermore, it will be appreciated that due to the feature of angle (6) between the top plane (5) and the basal plane (4), the entire top surface is sloping downward from the end (31) to the end (32) thus allowing any water that on the top surface to slide down the top surface by gravity, preventing any accumulation of water on the top surface (2) and thus reducing wastage. The bottom surface (2) is shaped in such a way that the area ratio, defined as ratio of area of the bottom surface (2) as projected on basal plane (4) to the area of the top surface (3) as projected on basal plane (4) is about 0.3. It will be appreciated that this embodiment would allow further reduction in wastage of bar due to the feature of the area ratio being less than 0.95, which allows for reduction in the area of soap surface in contact with water when supported on the bottom surface (2), and thus allows reduction in wastage of soap.

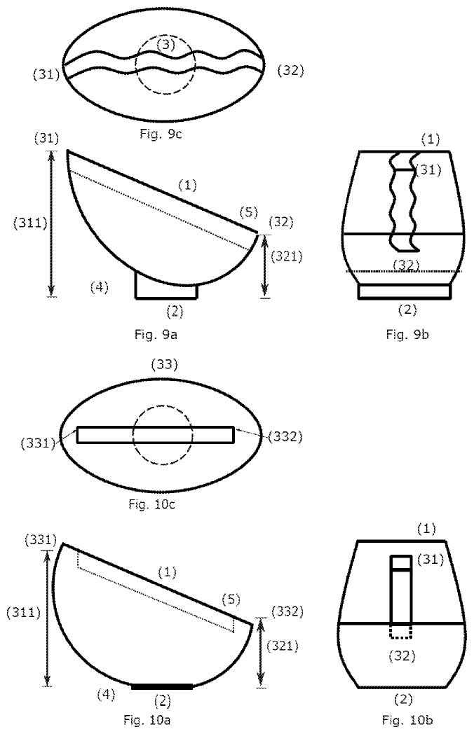

### FIG. 9

FIG. 9 depicts ninth embodiment according to the present invention, which is similar to the eighth embodiment depicted in FIG. 7, except for one different feature, in that the bottom surface (2) is shaped in such a way that there is a bottom support section defined by uniform cross-sectional area equal to the area of the bottom surface (2). It will be appreciated that during use when the bar is stored in wet places such as shower room or bath room, the bottom surface of (2) of the bar erodes away and the feature of the bottom support section positioned at the bottom of the bar, delays the time before which a larger cross-sectional area of the bar can contract the water, thus reducing the rate of erosion of bar and preventing wastage.

### FIG. 10

FIG. 10 depicts tenth embodiment according to the present invention. The groove (3) includes a blocked portion (33), which includes both of the following:
(a) a blocked portion (331) positioned at the first end (31) of the groove (3), and
(b) a blocked portion (332) positioned at the second end (32) of the groove (3).

The embodiment depicted in FIG. 10 leads to reduced wastage during storage. Furthermore, the feature of having blocked portions (331) and (332) helps in maintaining structural integrity of bars and allows the shape to be retained during stamping and shaping operation during manufacturing of soap. The avoidance of sharp edges at the groove ends helps in reducing chipping at the edges or breakage or damage of the bar during stamping and shaping steps. Thus the bars of FIG. 10 not only lead to reduced wastage but also to improvement in manufacturing process.

### EXAMPLES

The invention shall now be demonstrated by examples. The examples are for illustration purpose only and do not limit the scope of the invention in any manner.

### Examples 1-6 and Comparative Example A: Commercial Toilet Soaps

Toilet soaps commercially available in India were procured. According to the label information, the toilet soaps are grade 1 with total fatty matter of 76% by weight. The ingredients listed on the label are: Sodium palmitate, sodium palm kernelate, water, perfume, trichlocarbon, sodium chloride, glycerine, titanium dioxide, disoidium EDTA, BHT, citric acid, menthol and colour CI74160 and CI74260. The bars, which were typically brick shaped, were unwrapped and sculpted into various shapes using a set of artisanal sculpting and pottery tools. For Comparative Example A, bars were left in brick shape as bought, without making any changes from the brick shape. Bars of Examples 1, 2, 3, 4, 5, and 6 were shaped to correspond approximately to the shapes depicted in FIGS. 1,2,3,5,6, and 7, respectively

### Examples 7-12 and Comparative Example B: Commercial Bathing Bars

Bathing bars commercially available in India were procured. According to the label information, the ingredients listed are: Sodium lauryl isethionate, stearic acid, sodium palmitate, water, lauric acid, sodium isethionate, sodium stearate, cocamido propyl betaine, sodium palm kernelate, glycerine, perfume, sodium chloride, zinc oxide, propylene glycol, tetrasodium EDTA, tetrasodium etidronate, alumina, titanium dioxide, alpha isomethyl ionone, butyl phenyl methyl propional, citrnellol, coumarin, hexyl cinnamal, linalool, colour CI14700 and CI17200. Although not specifically mentioned on the label, total fatty matter of bathing bars is expected to be between 40-60% according to the Bureau of Indian Standards. The bars were unwrapped and sculpted into various shapes using a set of artisanal sculpting and pottery tools. For Comparative Example B, the bars were left without changing the shape. Bars of Examples 7, 8, 9, 10, 11, and 12 were shaped to correspond approximately to the shapes depicted in FIGS. 1, 2, 3, 5, 6, and, 7, respectively.

### Examples 13-19 and Comparative Example C

Soap bars with 45% total fatty matter were prepared by extrusion through a circular orifice. The cylindrical pieces were cut using knife to make cylinder shaped bars. This was followed immediately by introducing the cylinder shaped bars into a die a block, pressing the die and releasing the bars, which were thus shaped according to the shape of the die. Using this procedure, bars of Comparative Example C as well as Examples 13-19 were prepared. For Comparative Example C, the bars prepared were of brick shape. Dies used for bars of Examples 13-19 corresponded to the soap bar shapes according to the invention. Thus the bars of Examples 13, 14, 15, 16, 17, 18, 19, and 20 were prepared to correspond to shapes depicted in FIGS. 1, 3, 5, 6, 7, 8, and 10.

### Simulated In-Use Storage Conditions and Exposure to Water

Following experiments were carried to expose bars to water simulating the in-use or between-use storage in bathrooms or showers. All experiments were carried out in triplicate (three bars for each shape). All bars were weighed initially and kept in a soap dish individually. To simulate water exposure, 2 ml water was sprayed on top surface of each bar, using a spray bottle which created a fine spray. The spray was directed towards the top surface with care taken not to spray on the sides. After waiting for 15 minutes, the bar surface was wiped of using a tissue paper to remove the layer of mush formed on the top surface of bar. It was seen that mush, in any, was mainly formed on the top surface. The bars were weighed again after allowing 10 minutes time to dry. The water exposure cycles were repeated five times and final weights of all the bars were measured after 5 simulated exposure cycles, and the results are tabulated, as loss in weight of the bars, expressed as % of the original weight of the bar.

After this set of experiments, a different simulation of water exposure was carried out by pipetting 13 ml water on each of the bar in the soap dish, It was observed that this amount of water did not stay on top surface, but flowed down around the sides forming a pool of water at the bottom of the soap dish The bars were left for 30 minutes, after which water in the soap dish, if any was drained, and the entire surface of the bars was wiped using a tissue paper to remove the mush. After allowing 15 minutes for bars to dry, the bars were weighed again. The loss of weight was expressed as % of the original weight of the bar and the results are tabulated below.

TABLE 1
WEIGHT LOSS FOR BARS OF EXAMPLE
1-6 AND COMPARATIVE EXAMPLE A
All the results are reported as average of three bars

| | BAR | % Weight Loss after 5 | Weight loss (%) after one |
|---|---|---|---|
| EXAMPLE | SHAPE | cycles of 2 mL spray | cycle of 13 mL spray |
| A | BRICK | 3.56 | 3.9 |
| 1 | FIG. 1 | 1.1 | 3.5 |
| 2 | FIG. 2 | 0.8 | 1.1 |
| 3 | FIG. 3 | 2.1 | 0.7 |
| 4 | FIG. 5 | 0.8 | 0 |
| 5 | FIG. 6 | 0.2 | 0 |
| 6 | FIG. 7 | 0.7 | 0 |

From the above results, it is apparent that the toilet soap bars according to the present invention (corresponding to EXAMPLES 1-6) show reduced wastage as compared to the conventional brick shaped bar that is outside the scope of the present invention (corresponding to Comparative Example (A) as indicated by figures of % loss in bar weight as compared to original weight.

TABLE 2
WEIGHT LOSS FOR BARS OF EXAMPLE
7-12 AND COMPARATIVE EXAMPLE B
All the results are reported as average of three bars

| | | Weight Loss (%) | Weight loss (%) |
|---|---|---|---|
| | BAR | after 5 cycles | after one cycle |
| EXAMPLE | SHAPE | of 2 mL spray | of 13 mL spray |
| B | BRICK | 4.45 | 2.8 |
| 7 | FIG. 1 | 1.1 | 2.4 |
| 8 | FIG. 2 | 1.0 | 1.7 |
| 9 | FIG. 3 | 0.4 | 1.9 |
| 10 | FIG. 5 | 0.1 | 0 |
| 11 | FIG. 6 | 0.1 | 0 |
| 12 | FIG. 7 | 0.2 | 2.1 |

From the above results, it is apparent that the bathing bar soaps according to the present invention (corresponding to EXAMPLES 7-12) show reduced wastage as compared to the conventional brick shaped bar that is outside the scope of the present invention (corresponding to Comparative Example (B) as indicated by figures of % loss in bar weight as compared to original weight.

TABLE 3
WEIGHT LOSS FOR BARS OF EXAMPLE
13-19 AND COMPARATIVE EXAMPLE A
All the results are reported as average of three bars

| | BAR | % Weight Loss after 5 | Weight loss (%) after one |
|---|---|---|---|
| EXAMPLE | SHAPE | cycles of 2 mL spray | cycle of 13 mL spray |
| C | BRICK | 4.8 | 5.7 |
| 13 | FIG. 1 | 0.7 | 2.6 |
| 14 | FIG. 3 | 0.9 | 0.3 |
| 15 | FIG. 5 | 1.2 | 0.5 |
| 16 | FIG. 6 | 0.6 | 3.6 |
| 17 | FIG. 7 | 0 | 1.4 |
| 18 | FIG. 8 | 0 | 2.0 |
| 19 | FIG. 10 | 0 | 1.8 |

Tables 1-3 and data therein demonstrate that various embodiments of the invention according to the present invention show significant benefit in terms of reducing wastage of bar (as indicated by loss in % weight).

1. A soap or detergent bar including:
(a) a top surface, and;
(b) a bottom surface, and;
(c) a groove running across its top surface from a first end to a second end, wherein the height of the first end as measured from the bottom surface is greater than the height of the second end as measured from the bottom surface.

2. A soap or detergent bar as claimed in claim 1 wherein the bottom surface includes a basal plane that functions as a support for the soap bar, wherein said basal plane is defined by any one of the following:
(a) bottom surface includes at least three basal segments jutting outwards from the bottom, with the extremities of the segments being coplanar, thus defining a basal plane, or;
(b) the bottom surface is planar, thus defining a basal plane, or;
(c) the bottom surface is concave, and includes a bottom peripheral rim that is planar, thus defining the basal plane.

3. A soap or detergent bar as claimed in claim 1 having an area ratio that is less than or equal to 0.95, and greater than or equal to 0.05, where the area ratio is defined as ratio of area of the bottom surface as projected on basal plane to the area of the top surface as projected on basal plane.

4. A soap or detergent bar as claimed in claim 1 wherein the difference between the height of the first end and the height of the second end is greater than or equal to 1 mm.

5. A soap or detergent bar as claimed in claim 1 wherein angle between a top plane and a basal plane is at least 3 degrees, where the top plane is defined by any of the following:
(a) the top surface, excluding the groove, is planar, thus defining a top plane, or;
(b) the top surface has a top rim, said top rim is planar, thus defining the top plane.

6. A soap bar or detergent bar as claimed in claim 1 wherein the groove includes a blocked portion selected from one or both of the following:
(a) a blocked portion positioned at the first end of the groove, or;
(b) a blocked portion positioned at the second end of the groove.

7. A soap or detergent bar as claimed in claim 1 wherein the difference between the height of the first end and the height of the second end is greater than or equal to 2 mm.

8. A soap or detergent bar as claimed in claim 1 wherein the difference between the height of the first end and the height of the second end is greater than or equal to 3 mm.

9. A soap or detergent bar as claimed in claim 1 wherein the difference between the height of the first end and the height of the second end is greater than or equal to 5 mm.
